(19) United States
(12) Patent Application Publication
(10) Pub. No.: US 2026/0070418 A1
(43) Pub. Date: Mar. 12, 2026

(54) INFORMATION PROCESSING APPARATUS, INFORMATION PROCESSING METHOD, AND PROGRAM

(71) Applicant: Sony Group Corporation, Tokyo (JP)

(72) Inventors: Toshihiro Hirao, Kanagawa (JP); Ryu Tate, Tokyo (JP)

(73) Assignee: Sony Group Corporation, Tokyo (JP)

(21) Appl. No.: 19/103,912

(22) PCT Filed: Aug. 7, 2023
(86) PCT No.: PCT/JP2023/028735

§ 371 Date: Feb. 14, 2025

(30) Foreign Application Priority Data
Aug. 23, 2022 (JP) 2022-132278

(51) Int. Cl. B60K 35/81; B60K 35/22; B60K 35/65; G06F 3/0484; G06F 3/0488

(52) U.S. Cl. CPC B60K 35/81; B60K 35/22; B60K 35/654; G06F 3/0484; G06F 3/0488; B60K 2360/782

(57) ABSTRACT

The present technology relates to an information processing apparatus, an information processing method, and a program which are capable of improving operability of a vehicle.

The information processing apparatus includes a function setting unit that sets a function to be carried out by an operation unit, on the basis of a setting condition based on at least one of the state of a vehicle and the state of an occupant of the vehicle, and a display control unit that controls display, on the operation unit, of function information regarding the function set for the operation unit. The present technology is applicable to, for example, vehicles.

### TECHNICAL FIELD

The present technology relates to an information processing apparatus, an information processing method, and a program, and, in particular, relates to an information processing apparatus, an information processing method, and a program which are capable of improving operability of a vehicle.

### BACKGROUND ART

In related art, it has been proposed to enable setting of the contents of an operation of an operation unit in front of a driver's seat of a vehicle, and to cause the contents of the operation to be displayed at a position overlapping with the operation unit on a display panel (see, for example, PTL 1).

### CITATION LIST

### Patent Literature

### [PTL 1]

JP 2022-78862A

### SUMMARY

### Technical Problem

However, in an invention described in PTL 1, the contents of the operation of the operation unit is not changed from the contents set beforehand, regardless of the state of a vehicle or the state of an occupant.

The present technology has been conceived in view of the above circumstances to improve operability of a vehicle.

### Solution to Problem

An information processing apparatus according to one aspect of the present technology includes a function setting unit that sets a function to be carried out by an operation unit, on the basis of a setting condition based on at least one of a state of a vehicle and a state of an occupant of the vehicle, and a display control unit that controls display, on the operation unit, of function information regarding the function set for the operation unit.

An information processing method according to one aspect of the present technology includes setting a function to be carried out by an operation unit, on the basis of a setting condition based on at least one of a state of a vehicle and a state of an occupant of the vehicle, and controlling display, on the operation unit, of function information regarding the function set for the operation unit.

A program according to one aspect of the present technology causes a computer to perform the processes of setting a function to be carried out by an operation unit, on the basis of a setting condition based on at least one of a state of a vehicle and a state of an occupant of the vehicle, and controlling display, on the operation unit, of function information regarding the function set for the operation unit.

According to one aspect of the present technology, a function to be carried out by an operation unit is set on the basis of a setting condition based on at least one of a state of a vehicle and a state of an occupant of the vehicle, and display, on the operation unit, of function information regarding the function set for the operation unit is controlled.

### BRIEF DESCRIPTION OF DRAWINGS

FIG. 1 is a block diagram illustrating an example configuration of a vehicle control system.

FIG. 2 is a diagram illustrating examples of sensing regions.

FIG. 3 is a block diagram illustrating an example configuration of an operation system.

FIG. 4 is a schematic diagram illustrating an example arrangement of steering switches.

FIG. 5 depicts schematic diagrams each illustrating an example configuration of the steering switch.

FIG. 6 depicts schematic diagrams each illustrating an example configuration of the steering switch.

FIG. 7 is a flowchart for explaining a steering switch control process.

FIG. 8 depicts diagrams illustrating example arrangements of functions of the steering switches in a parked state.

FIG. 9 is a diagram illustrating example arrangements of the functions of the steering switches during manual driving.

FIG. 10 depicts diagrams illustrating example arrangements of the functions of the steering switches during automated driving.

FIG. 11 depicts diagrams illustrating example arrangements of functions of a variable operation switch in the parked state or during automated driving.

FIG. 12 is a diagram illustrating an example arrangement of the functions of the variable operation switch during manual driving.

FIG. 13 is a block diagram illustrating an example configuration of a computer.

### DESCRIPTION OF EMBODIMENTS

Hereinafter, modes for carrying out the present technology will be described. Descriptions will be provided in the following order.
1. Example configuration of vehicle control system
2. Embodiments
3. Example modifications
4. Others

### 1. Example Configuration of Vehicle Control System

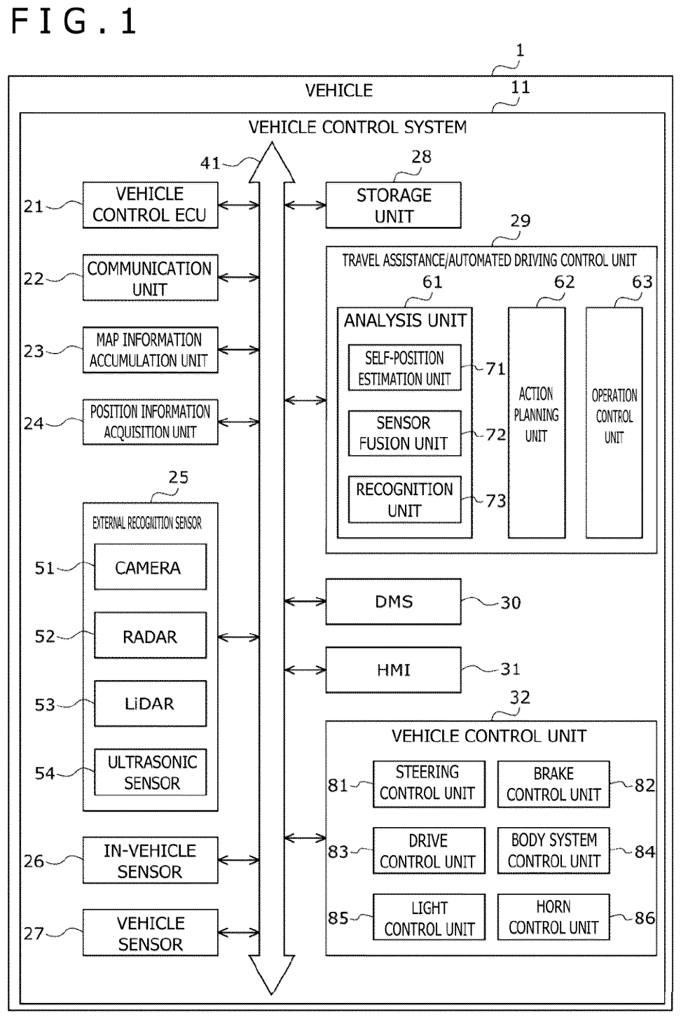

FIG. 1 is a block diagram illustrating an example configuration of a vehicle control system 11, which is an example of a moving apparatus control system to which the present technology is applied.

The vehicle control system 11 is provided in a vehicle 1, and performs processes related to travel assistance and automated driving of the vehicle 1.

The vehicle control system 11 includes a vehicle control ECU (Electronic Control Unit) 21, a communication unit 22, a map information accumulation unit 23, a position information acquisition unit 24, an external recognition sensor 25, an in-vehicle sensor 26, a vehicle sensor 27, a storage unit 28, a travel assistance/automated driving control unit 29, a DMS (Driver Monitoring System) 30, an HMI (Human Machine Interface) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance/automated driving control unit 29, the driver monitoring system (DMS) 30, the human machine interface (HMI) 31, and the vehicle control unit 32 are connected to one another via a communication network 41 so as to be capable of communicating with one another. The communication network 41 is formed by, for example, an in-vehicle communication network, a bus, or the like which is in conformity with a standard of digital bidirectional communication, such as a CAN (Controller Area Network), a LIN (Local Interconnect Network), a LAN (Local Area Network), FlexRay (registered trademark), or Ethernet (registered trademark). Different types of communication networks 41 may be used according to the type of data to be transferred. For example, the CAN may be applied to data related to vehicle control, while Ethernet may be applied to high-volume data. Note that portions of the vehicle control system 11 may be directly connected to one another, using wireless communication designed for relatively short-range communication, such as, for example, NFC (Near Field Communication) or Bluetooth (registered trademark), without the intervention of the communication network 41.

Note that, hereinafter, in the case where portions of the vehicle control system 11 communicate with one another through the communication network 41, a description of the communication network 41 will be omitted. For example, in the case where the vehicle control ECU 21 and the communication unit 22 communicate with each other through the communication network 41, such a simple description in the following will be used that the vehicle control ECU 21 and the communication unit 22 communicate with each other.

The vehicle control ECU 21 includes, for example, a CPU (Central Processing Unit), an MPU (Micro Processing Unit), or any of various other types of processors. The vehicle control ECU 21 controls all or some of functions of the vehicle control system 11.

The communication unit 22 communicates with various devices inside or outside the vehicle, another vehicle, a server, a base station, and so on, and performs transmission and reception of various types of data. At this time, the communication unit 22 is capable of performing communication through a plurality of communication methods.

Communication that the communication unit 22 is capable of performing with entities outside the vehicle will be roughly described below. The communication unit 22, for example, performs communication with a server (hereinafter referred to as an external server) that is present on an external network or the like through a base station or an access point by a wireless communication method, such as 5G (fifth-generation mobile communication system), LTE (Long Term Evolution), or DSRC (Dedicated Short Range Communications). Examples of external networks which the communication unit 22 communicates with include the Internet, a cloud network, and a network specific to a business entity. The communication methods adopted for the communication unit 22 to communicate with such external networks are not limited to particular methods as long as the communication methods are wireless communication methods that allow digital bidirectional communication at a predetermined transfer speed or higher and over a distance of a predetermined length or more.

In addition, for example, the communication unit 22 is capable of communicating with a terminal that is present in the vicinity of the host vehicle by using P2P (Peer To Peer) technology. Examples of terminals that are present in the vicinity of the host vehicle include a terminal attached to a movable body that moves at a relatively low speed, such as a pedestrian or a bicycle, a fixed terminal installed at a store or the like, or an MTC (Machine Type Communication) terminal. Further, the communication unit 22 is also capable of performing V2X communication. The V2X communication refers to communication between the host vehicle and another entity, such as, for example, vehicle to vehicle communication performed with another vehicle, vehicle to infrastructure communication performed with a roadside unit or the like, vehicle to home communication performed with a home, or vehicle to pedestrian communication performed with a terminal carried by a pedestrian or the like.

The communication unit 22 is, for example, capable of receiving, from an external entity, a program for updating software that controls an operation of the vehicle control system 11 (Over The Air). The communication unit 22 is further capable of receiving, from external entities, map information, traffic information, information concerning the surroundings of the vehicle 1, and so on. In addition, for example, the communication unit 22 is capable of transmitting information concerning the vehicle 1, information concerning the surroundings of the vehicle 1, and so on to external entities. Examples of information concerning the vehicle 1 which the communication unit 22 transmits to an external entity include data indicating the state of the vehicle 1, a recognition result obtained by the recognition unit 73, and the like. Further, for example, the communication unit 22 performs communication for a vehicle emergency call system, such as eCall.

For example, the communication unit 22 receives electromagnetic waves transmitted by a road traffic information communication system (VICS (Vehicle Information and Communication System) (registered trademark)), such as a radio wave beacon, an optical beacon, or FM multiplex broadcasting.

Communication that the communication unit 22 is capable of performing with entities inside the vehicle will be roughly described below. The communication unit 22 is capable of communicating with various devices inside the vehicle by using, for example, wireless communication. The communication unit 22 is, for example, capable of performing wireless communication with devices inside the vehicle by using a communication method that allows digital bidirectional communication at a predetermined transfer speed or higher with wireless communication, such as a wireless LAN, Bluetooth, NFC, or a WUSB (Wireless USB). Instead of being limited to this, the communication unit 22 is also capable of communicating with various devices inside the vehicle by using wired communication. For example, the communication unit 22 is capable of communicating with various devices inside the vehicle by using wired communication via cables connected to connection terminals, which are not depicted. The communication unit 22 is, for example, capable of communicating with various devices inside the vehicle by using a communication method that allows digital bidirectional communication at a predetermined transfer speed or higher with wired communication, such as a USB (Universal Serial Bus), an HDMI (High-Definition Multimedia Interface) (registered trademark), or an MHL (Mobile High-definition Link).

Here, the devices inside the vehicle refer to, for example, devices that are not connected to the communication network 41 inside the vehicle. Examples of the devices inside the vehicle which can be expected include a mobile appliance or wearable appliance carried by an occupant, such as a driver, and an information appliance carried into and temporarily installed in the vehicle.

The map information accumulation unit 23 accumulates one or both of maps acquired from an external entity, and maps generated in the vehicle 1. For example, the map information accumulation unit 23 accumulates three-dimensional high-precision maps, global maps that are lower in precision and cover a wider area than high-precision maps, and so on.

Examples of the high-precision maps include a dynamic map, a point cloud map, a vector map, and the like. The dynamic map is, for example, a map including four layers of dynamic information, semi-dynamic information, semi-static information, and static information, and is provided to the vehicle 1 from an external server or the like. The point cloud map is a map including point clouds (point group data). The vector map is, for example, a map in which traffic information, such as the positions of a lane and a traffic light, and so on are associated with a point cloud map, and which is thus suitable for an ADAS (Advanced Driver Assistance System) and AD (Autonomous Driving).

The point cloud map and the vector map may be provided from, for example, an external server or the like, or may be generated in the vehicle 1 as maps to be subjected to matching with a local map, which will be described below, on the basis of a sensing result obtained by a camera 51, a radar 52, a LiDAR 53, or the like, and be accumulated in the map information accumulation unit 23. In addition, in the case where a high-precision map is provided from an external server or the like, map data concerning a planned route that the vehicle 1 is now going to travel over and covering, for example, several hundred meters square is acquired from the external server or the like, in order to reduce communication capacity.

The position information acquisition unit 24 receives, from a GNSS (Global Navigation Satellite System) satellite, a GNSS signal, and acquires position information of the vehicle 1. The acquired position information is supplied to the travel assistance/automated driving control unit 29. Note that the position information acquisition unit 24 may not necessarily employ the method using the GNSS signal, and may acquire the position information using, for example, a beacon.

The external recognition sensor 25 includes various types of sensors used to recognize a situation outside the vehicle 1, and supplies sensor data from each sensor to various portions of the vehicle control system 11. The types and number of sensors included in the external recognition sensor 25 are optional.

For example, the external recognition sensor 25 includes the camera 51, the radar 52, the LiDAR (Light Detection and Ranging, Laser Imaging Detection and Ranging) 53, and an ultrasonic sensor 54. Instead of being limited to this, the external recognition sensor 25 may include one or more types of sensors among the camera 51, the radar 52, the LiDAR 53, and the ultrasonic sensor 54. Any desired numbers of camera 51, radar 52, LiDAR 53, and ultrasonic sensor 54 may be installed on the vehicle 1 as long as that is practically possible. In addition, the types of sensors included in the external recognition sensor 25 are not limited to the above examples, and the external recognition sensor 25 may include other types of sensors. Examples of a sensing region of each of the sensors included in the external recognition sensor 25 will be described below.

Note that an imaging system of the camera 51 is not limited to any particular imaging system. Cameras supporting various types of imaging systems, such as a stereo camera, a monocular camera, an infrared camera, and a ToF (Time Of Flight) camera, supporting an imaging system capable of distance measurement, for example, can be adopted as the camera 51 as necessary. Further, a camera for simply acquiring captured images regardless of distance measurement may be adopted as the camera 51.

In addition, for example, the external recognition sensor 25 may include an environment sensor for detecting an environment for the vehicle 1. The environment sensor is a sensor for detecting an environment, such as weather, atmospheric conditions, or brightness, and may include any of various types of sensors, such as, for example, a raindrop sensor, a fog sensor, a sunshine sensor, a snow sensor, and an illumination sensor.

Furthermore, for example, the external recognition sensor 25 includes a microphone used for detecting a sound around the vehicle 1, the position of a sound source, and so on.

The in-vehicle sensor 26 includes various types of sensors for detecting information inside the vehicle, and supplies sensor data from each sensor to various portions of the vehicle control system 11. The types and number of various types of sensors included in the in-vehicle sensor 26 are not limited to particular types or numbers as long as the types and number practically allow the various types of sensors to be installed on the vehicle 1.

For example, the in-vehicle sensor 26 may include one or more types of sensors among a camera, a radar, a seating sensor, a steering wheel sensor, a microphone, and a biological sensor. Cameras supporting various types of imaging systems capable of distance measurement, such as a ToF camera, a stereo camera, a monocular camera, and an infrared camera, for example, can be used as a camera included in the in-vehicle sensor 26. Further, a camera for simply acquiring captured images regardless of distance measurement may be adopted as a camera included in the in-vehicle sensor 26. A biological sensor included in the in-vehicle sensor 26 is, for example, provided in a seat, a steering wheel, or the like, to detect various types of biological information of an occupant, such as the driver.

The vehicle sensor 27 includes various types of sensors for detecting the state of the vehicle 1, and supplies sensor data from each sensor to various portions of the vehicle control system 11. The types and number of various types of sensors included in the vehicle sensor 27 are not limited to particular types or numbers as long as the types and number practically allow the various types of sensors to be installed on the vehicle 1.

For example, the vehicle sensor 27 includes a speed sensor, an acceleration sensor, an angular velocity sensor (gyro sensor), and an IMU (Inertial Measurement Unit) that integrates such sensors. For example, the vehicle sensor 27 includes a steering angle sensor for detecting the steering angle of the steering wheel, a yaw rate sensor, an accelerator sensor for detecting the operation amount of an accelerator pedal, and a brake sensor for detecting the operation amount of a brake pedal. For example, the vehicle sensor 27 includes a rotation sensor for detecting the rotation speed of an engine or a motor, an air pressure sensor for detecting the air pressure of a tire, a slip ratio sensor for detecting the slip ratio of a tire, and a wheel speed sensor for detecting the rotation speed of a wheel. For example, the vehicle sensor 27 includes a battery sensor for detecting the remaining charge and temperature of a battery, and an impact sensor for detecting an external impact.

The storage unit 28 includes at least one of a nonvolatile storage medium and a volatile storage medium, and stores data and programs. The storage unit 28 is used as, for example, an EEPROM (Electrically Erasable Programmable Read Only Memory) and a RAM (Random Access Memory), and may adopt each of a magnetic storage device, such as an HDD (Hard Disc Drive), a semiconductor storage device, an optical storage device, and a magneto-optical storage device as a storage medium. The storage unit 28 stores data and various types of programs used by various portions of the vehicle control system 11. For example, the storage unit 28 includes an EDR (Event Data Recorder) and a DSSAD (Data Storage System for Automated Driving), and stores information acquired by the in-vehicle sensor 26 and information concerning the vehicle 1 before and after an event, such as an accident.

The travel assistance/automated driving control unit 29 controls travel assistance and automated driving of the vehicle 1. For example, the travel assistance/automated driving control unit 29 includes an analysis unit 61, an action planning unit 62, and an operation control unit 63.

The analysis unit 61 performs a process of analyzing the situations of the vehicle 1 and the surroundings thereof. The analysis unit 61 includes a self-position estimation unit 71, a sensor fusion unit 72, and a recognition unit 73.

The self-position estimation unit 71 estimates the self-position of the vehicle 1 on the basis of the sensor data from the external recognition sensor 25 and the high-precision map accumulated in the map information accumulation unit 23. For example, the self-position estimation unit 71 generates a local map on the basis of the sensor data from the external recognition sensor 25, and subjects the local map and the high-precision map to matching, thereby estimating the self-position of the vehicle 1. The position of the vehicle 1 is based on, for example, a center of a rear wheel pair axle.

The local map is, for example, a three-dimensional high-precision map generated by using a technique such as SLAM (Simultaneous Localization and Mapping), an occupancy grid map, or the like. The three-dimensional high-precision map is, for example, a point cloud map mentioned above or the like. The occupancy grid map is a map in which a three-dimensional or two-dimensional space around the vehicle 1 is divided into grid cells each having a predetermined size and each indicating the state of occupancy by an object. The state of occupancy by an object is expressed as, for example, presence/absence of an object or the probability of presence of an object. The local map is, for example, used also in processes of detecting and recognizing the situation outside the vehicle 1 performed by the recognition unit 73.

Note that the self-position estimation unit 71 may estimate the self-position of the vehicle 1 on the basis of the position information acquired by the position information acquisition unit 24 and the sensor data from the vehicle sensor 27.

The sensor fusion unit 72 performs a sensor fusion process of combining a plurality of different types of sensor data (e.g., image data supplied from the camera 51, and sensor data supplied from the radar 52) to obtain new information. Methods for combining different types of sensor data include integration, fusion, association, and so on.

The recognition unit 73 performs the detection process of detecting the situation outside the vehicle 1, and the recognition process of recognizing the situation outside the vehicle 1.

For example, the recognition unit 73 performs the processes of detecting and recognizing the situation outside the vehicle 1 on the basis of information from the external recognition sensor 25, information from the self-position estimation unit 71, information from the sensor fusion unit 72, and so on.

Specifically, the recognition unit 73 performs, for example, processes of detecting and recognizing an object around the vehicle 1 and so on. The process of detecting an object is, for example, a process of detecting the presence/absence, size, shape, position, movement, etc., of an object. The process of recognizing an object is, for example, a process of recognizing an attribute, such as a type, of an object, or identifying a specific object. Note, however, that the detection process and the recognition process are not necessarily clearly separated, and may overlap in some cases.

For example, the recognition unit 73 detects an object around the vehicle 1 by performing clustering of classifying point clouds based on sensor data obtained by the radar 52, the LiDAR 53, or the like into groups of point clusters. The presence/absence, size, shape, and position of an object around the vehicle 1 can thus be detected.

For example, the recognition unit 73 detects a movement of an object around the vehicle 1 by performing tracking of following a movement of a point cluster resulting from the classification by the clustering. The speed and direction of travel (i.e., movement vector) of the object around the vehicle 1 can thus be detected.

For example, the recognition unit 73 detects or recognizes a vehicle, a person, a bicycle, an obstacle, a structure, a road, a traffic light, a traffic sign, a road marking, etc., on the basis of image data supplied from the camera 51. In addition, the recognition unit 73 may recognize the type of an object around the vehicle 1 by performing a recognition process such as semantic segmentation.

For example, the recognition unit 73 is capable of performing a process of recognizing a traffic rule around the vehicle 1 on the basis of a map accumulated in the map information accumulation unit 23, a result of estimation of the self-position by the self-position estimation unit 71, and a result of recognition of an object around the vehicle 1 by the recognition unit 73. By this process, the recognition unit 73 is capable of recognizing the position and state of a traffic light, the contents of a traffic sign and a road marking, the details of a traffic restriction, a travelable lane, etc.

For example, the recognition unit 73 is capable of performing a process of recognizing an environment around the vehicle 1. Examples of surrounding environments that the recognition unit 73 is expected to recognize include the weather, temperature, humidity, brightness, and the state of a road surface.

The action planning unit 62 generates an action plan of the vehicle 1. For example, the action planning unit 62 generates the action plan by performing processes of path planning and path following.

Note that the path planning (Global path planning) is a process of making a rough plan of a path from a start to a goal. This path planning includes a process, called local path planning, of generating a local path that the vehicle 1 is able to safely and smoothly travel over in the vicinity of the vehicle 1 (Local path planning) within the planned path with motion characteristics of the vehicle 1 taken into consideration.

The path following is a process of making a plan of an operation for completing safe and accurate travel through the path planned by the path planning within a planned time. The action planning unit 62 is, for example, capable of calculating the target speed and the target angular velocity of the vehicle 1 on the basis of a result of the process of this path following.

The operation control unit 63 controls an operation of the vehicle 1 to realize the action plan generated by the action planning unit 62.

For example, the operation control unit 63 controls a steering control unit 81, a brake control unit 82, and a drive control unit 83 included in the vehicle control unit 32, which will be described below, to perform acceleration/deceleration control and direction control such that the vehicle 1 will travel on a local path computed by the local path planning. For example, the operation control unit 63 performs cooperative control for the purpose of implementing functions of the ADAS, such as collision avoidance or impact mitigation, following travel, vehicle speed-maintaining travel, collision warning for the host vehicle, and lane departure warning for the host vehicle. For example, the operation control unit 63 performs cooperative control for the purpose of automated driving or the like, which enables autonomous travel without an operation by the driver.

The DMS 30 performs a process of authenticating the driver, a process of recognizing the state of the driver, etc., on the basis of sensor data from the in-vehicle sensor 26, input data inputted to the HMI 31, which will be described below, and so on. Examples of the state of the driver which are expected to be recognized include a physical condition, the level of wakefulness, the level of concentration, the degree of fatigue, the direction of a line of sight, the level of intoxication, a driving operation, a posture, and the like.

Note that the DMS 30 may be configured to perform a process of authenticating an occupant other than the driver, and a process of recognizing the state of the occupant. Also, note that, for example, the DMS 30 may be configured to perform a process of recognizing a situation inside the vehicle on the basis of sensor data from the in-vehicle sensor 26. Examples of the situation inside the vehicle which are expected to be recognized include temperature, humidity, brightness, smell, and the like.

The HMI 31 performs input of various types of data, instructions, etc., and presents various types of data to the driver and so on.

The input of data by the HMI 31 will be roughly described below. The HMI 31 includes an input device for data input by a person. The HMI 31 generates input signals on the basis of data, instructions, etc., inputted through the input device, and supplies the input signals to various portions of the vehicle control system 11. The HMI 31 includes, as input devices, operation parts, such as a touchscreen panel, a button, a switch, and a lever, for example. Instead of being limited to this, the HMI 31 may further include an input device that enables input of information by a method other than manual operation, such as via voice or gesture. Further, the HMI 31 may use, as an input device, a remote control device utilizing infrared rays or radio waves, or an external connection device, such as a mobile appliance or a wearable appliance, which supports the operation of the vehicle control system 11, for example.

The presentation of data by the HMI 31 will be roughly described below. The HMI 31 generates visual information, audio information, and tactile information for an occupant or a space outside the vehicle. In addition, the HMI 31 performs output control of controlling an output, the contents of an output, output timing, an output method, and so on of each piece of generated information. The HMI 31 generates and outputs, as visual information, information represented by an image or light, such as an operation screen, an indication of the state of the vehicle 1, an indication of a warning, and/or a monitor image representing the situation of the surroundings of the vehicle 1, etc., for example. In addition, the HMI 31 generates and outputs, as audio information, information represented by sound, such as a voice guidance, a warning sound, and/or a warning message, etc., for example. Further, the HMI 31 generates and outputs, as tactile information, information to be given to the sense of touch of an occupant via a force, vibration, motion, or the like, for example.

As output devices through which the HMI 31 outputs visual information, a display apparatus that presents visual information by displaying an image by itself, and a projector apparatus that presents visual information by projecting an image, for example, can be adopted. Note that the display apparatus may be, for example, an apparatus that displays visual information within the field of view of an occupant, such as a head-up display, a transmissive display, or a wearable device having an AR (Augmented Reality) function, as well as a display apparatus having a normal display. In addition, the HMI 31 may use, as an Output device through which visual information is outputted, a display device included in a navigation apparatus, an instrument panel, a CMS (Camera Monitoring System), an electron mirror, a lamp, or the like provided in the vehicle 1.

As output devices through which the HMI 31 outputs audio information, an audio speaker, headphones, and an earphone, for example, can be adopted.

As an output device through which the HMI 31 outputs tactile information, a haptic element utilizing haptic technology, for example, can be adopted. The haptic element is disposed, for example, in a portion, such as the steering wheel or a seat, with which an occupant of the vehicle 1 will be in contact.

The vehicle control unit 32 controls various portions of the vehicle 1. The vehicle control unit 32 includes the steering control unit 81, the brake control unit 82, the drive control unit 83, a body system control unit 84, a light control unit 85, and a horn control unit 86.

The steering control unit 81 detects the state of a steering system of the vehicle 1, and controls the steering system, for example. The steering system includes, for example, a steering mechanism including the steering wheel, etc., an electric power steering, and so on. The steering control unit 81 includes, for example, a steering ECU that controls the steering system, an actuator that drives the steering system, and so on.

The brake control unit 82 detects the state of a brake system of the vehicle 1, and controls the brake system, for example. The brake system includes, for example, a brake mechanism including the brake pedal, etc., an ABS (Antilock Brake System), a regenerative brake mechanism, and so on. The brake control unit 82 includes, for example, a brake ECU that controls the brake system, an actuator that drives the brake system, and so on.

The drive control unit 83 detects the state of a drive system of the vehicle 1, and controls the drive system, for example. The drive system includes, for example, the accelerator pedal, a driving force generator for generating a driving force of an internal combustion engine, a driving motor, or the like, a driving force transmission mechanism for transmitting the driving force to wheels, and so on. The drive control unit 83 includes, for example, a drive ECU that controls the drive system, an actuator that drives the drive system, and so on.

The body system control unit 84 detects the state of a body system of the vehicle 1, and controls the body system, for example. The body system includes, for example, a keyless entry system, a smart key system, a power window device, a power seat, an air conditioner, an air bag, a seat belt, a shift lever, and so on. The body system control unit 84 includes, for example, a body system ECU that controls the body system, an actuator that drives the body system, and so on.

The light control unit 85 detects the states of various types of lights of the vehicle 1, and controls the various types of lights, for example. As the lights to be controlled, for example, a headlight, a backlight, a fog light, turn signals, a brake light, a projection, a bumper indicator, and so on are assumed. The light control unit 85 includes a light ECU that controls the lights, actuators that drive the lights, and so on.

The horn control unit 86 detects the state of a car horn of the vehicle 1, and controls the car horn, for example. The horn control unit 86 includes, for example, a horn ECU that controls the car horn, an actuator that drives the car horn, and so on.

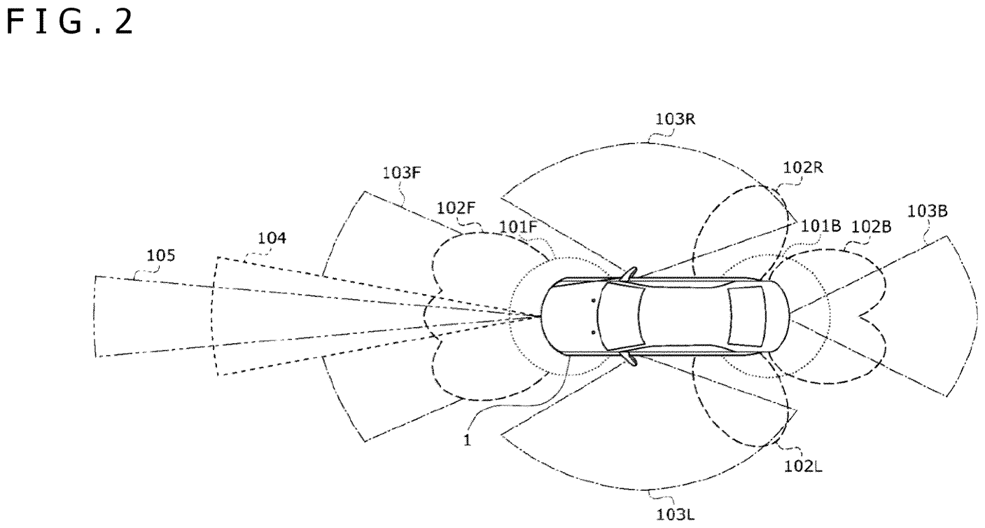

FIG. 2 is a diagram illustrating examples of sensing regions sensed by the camera 51, the radar 52, the LiDAR 53, the ultrasonic sensor 54, etc., in the external recognition sensor 25 in FIG. 1. Note that, in FIG. 2, the vehicle 1 as viewed from above is schematically depicted with a front end of the vehicle 1 on the left side and a rear end of the vehicle 1 on the right side.

A sensing region 101F and a sensing region 101B represent examples of sensing regions of the ultrasonic sensor 54. The sensing region 101F is a surrounding region of the front end of the vehicle 1 covered by a plurality of ultrasonic sensor 54. The sensing region 101B is a surrounding region of the rear end of the vehicle 1 covered by a plurality of ultrasonic sensor 54.

Results of sensing in the sensing region 101F and the sensing region 101B are used for, for example, parking assistance, etc., of the vehicle 1.

Sensing regions 102F to 102B represent examples of sensing regions of radars 52 for a short distance or a middle distance. The sensing region 102F covers positions farther than the sensing region 101F in front of the vehicle 1. The sensing region 102B covers positions farther than the sensing region 101B behind the vehicle 1. The sensing region 102L covers an area near a rearward portion of a left side surface of the vehicle 1. The sensing region 102R covers an area near a rearward portion of a right side surface of the vehicle 1.

A result of sensing in the sensing region 102F is used, for example, for detection or the like of a vehicle, a pedestrian, or the like that is present in front of the vehicle 1. A result of sensing in the sensing region 102B is used, for example, for a collision prevention function or the like behind the vehicle 1. Results of sensing in the sensing region 102L and the sensing region 102R are used, for example, for detection or the like of an object in a blind spot to the side of the vehicle 1.

Sensing regions 103F to 103B represent examples of sensing regions sensed by the cameras 51. The sensing region 103F covers positions farther than the sensing region 102F in front of the vehicle 1. The sensing region 103B covers positions farther than the sensing region 102B behind the vehicle 1. The sensing region 103L covers an area near the left side surface of the vehicle 1. The sensing region 103R covers an area near the right side surface of the vehicle 1.

Results of sensing in the sensing region 103F can be used for, for example, recognition of a traffic light or a traffic sign, a lane departure prevention support system, and an automatic headlight control system. Results of sensing in the sensing region 103B can be used for, for example, parking assistance and a surround view system. Results of sensing in the sensing region 103L and the sensing region 103R can be used for, for example, the surround view system.

A sensing region 104 represents an example of a sensing region of the LiDAR 53. The sensing region 104 covers positions farther than the sensing region 103F in front of the vehicle 1. Conversely, the sensing region 104 has a narrower range in the left-right direction than the sensing region 103F.

Results of sensing in the sensing region 104 are used for, for example, detection of an object, such as a vehicle nearby.

A sensing region 105 represents an example of a sensing region of a radar 52 for a long distance. The sensing region 105 covers positions farther than the sensing region 104 in front of the vehicle 1. Conversely, the sensing region 105 has a narrower range in the left-right direction than the sensing region 104.

Results of sensing in the sensing region 105 are used for, for example, ACC (Adaptive Cruise Control), an emergency brake, collision avoidance, and so on.

Note that the sensing regions of the various sensors included in the external recognition sensor 25, such as the camera 51, the radar 52, the LiDAR 53, and the ultrasonic sensor 54, may have various configurations other than the configuration of FIG. 2. Specifically, the ultrasonic sensor 54 may be used to sense regions to the side of the vehicle 1, and the LiDAR 53 may be used to sense a region behind the vehicle 1. Also, note that the positions at which the various sensors are disposed are not limited to the examples described above. Also, note that the number of each type of sensors may be one or more than one.

### 2. Embodiments

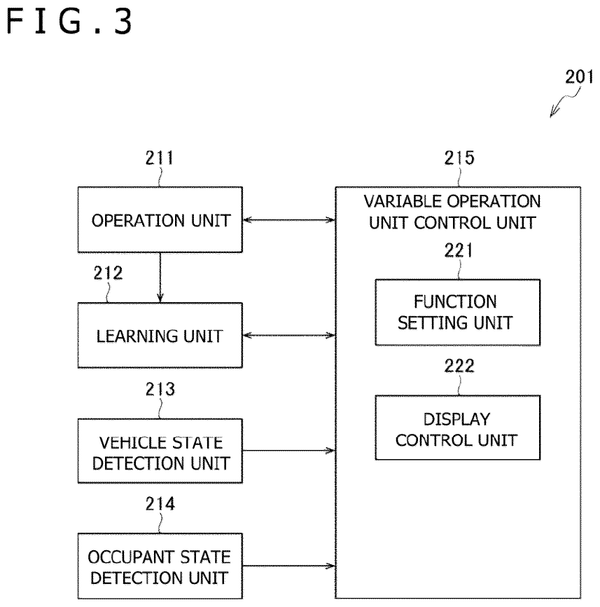

Next, an embodiment of the present technology will be described below with reference to FIGS. 3 to 10.

### <Example Configuration of Operation System 201>

FIG. 3 illustrates an example configuration of an operation system 201 to which the present technology is applied.

The operation system 201 is a system that is applicable to the vehicle 1. For example, the operation system 201 forms portions of the vehicle sensor 27, the DMS 30, the HMI 31, the vehicle control unit 32, the recognition unit 73, etc., of the vehicle 1.

The operation system 201 includes an operation unit 211, a learning unit 212, a vehicle state detection unit 213, an occupant state detection unit 214, and a variable operation unit control unit 215.

The operation unit 211 forms a portion of the HMI 31 of the vehicle 1, for example. The operation unit 211 is used to operate the vehicle 1. The operation unit 211 supplies an operation signal indicating the contents of operations to the learning unit 212 and the variable operation unit control unit 215. It is possible to change functions to be operated by a variable operation unit, which constitutes part of the operation unit 211, under control of the variable operation unit control unit 215.

The learning unit 212 records an operation history of an occupant and a history of use of each function of the HMI 31 by the occupant on the basis of, for example, the operation signals from the operation unit 211. The learning unit 212 learns characteristics of the occupant (e.g., preferences, habits, etc., of the occupant) on the basis of at least one of the operation history of the occupant and the history of use of each function of the HMI 31 by the occupant. The learning unit 212 supplies information representing a result of learning the characteristics of the occupant to the variable operation unit control unit 215.

The vehicle state detection unit 213, for example, forms portions of the vehicle sensor 27 and the vehicle control unit 32. The vehicle state detection unit 213 detects the state of the vehicle 1, and supplies information representing a result of the detection to the variable operation unit control unit 215.

The occupant state detection unit 214, for example, forms a portion of the DMS 30 of the vehicle 1. The occupant state detection unit 214 detects the state of an occupant of the vehicle 1, and supplies information representing a result of the detection to the variable operation unit control unit 215.

The variable operation unit control unit 215 controls the functions and display of the variable operation units, each of which is variable in functions to be carried out thereby. The variable operation unit control unit 215 includes a function setting unit 221 and a display control unit 222.

The function setting unit 221 sets the functions to be carried out by the variable operation unit, on the basis of at least one of an operation signal from the operation unit 211, a result of learning of the characteristics of an occupant by the learning unit 212, the state of the vehicle 1, and the state of the occupant.

The display control unit 222 controls display of function information on the variable operation unit, the function information regarding the function assigned by the function setting unit 221 to the variable operation unit.

### <Specific Examples of Configuration of Variable Operation Units>

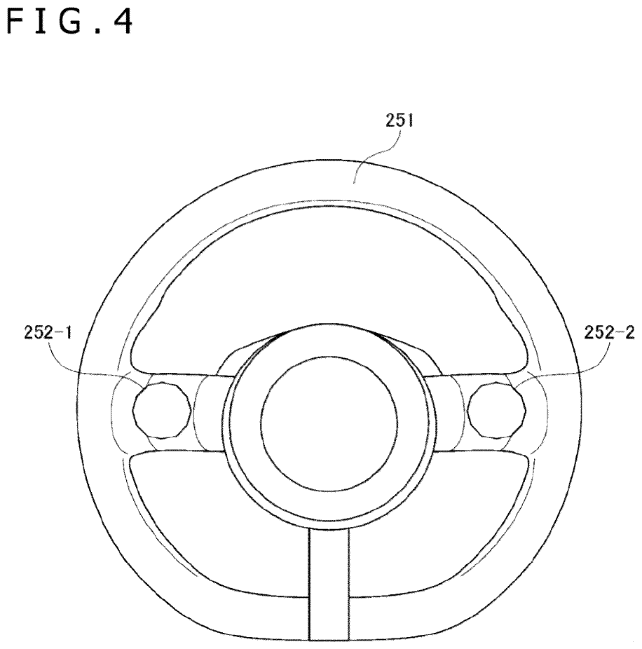

FIGS. 4 to 6 illustrate specific examples of the configuration of the variable operation unit.

Specifically, FIG. 4 schematically illustrates a steering wheel 251 of the vehicle 1.

A steering switch 252-1, which is the variable operation unit, is disposed in a left-side spoke of the steering wheel 251. The steering switch 252-1 is in the shape of a regular dodecagon that is nearly circular.

A steering switch 252-2, which is the variable operation unit, is disposed in a right-side spoke of the steering wheel 251. The steering switch 252-2 has a shape similar to that of the steering switch 252-1.

Hereinafter, the steering switch 252-1 and the steering switch 252-2 will be referred to simply as steering switches 252 unless they need to be distinguished from each other.

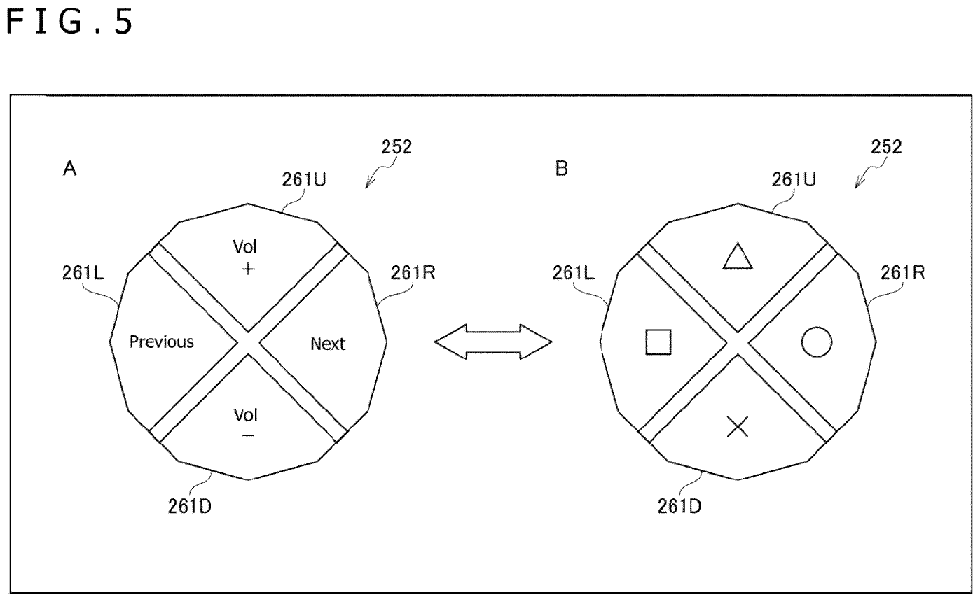

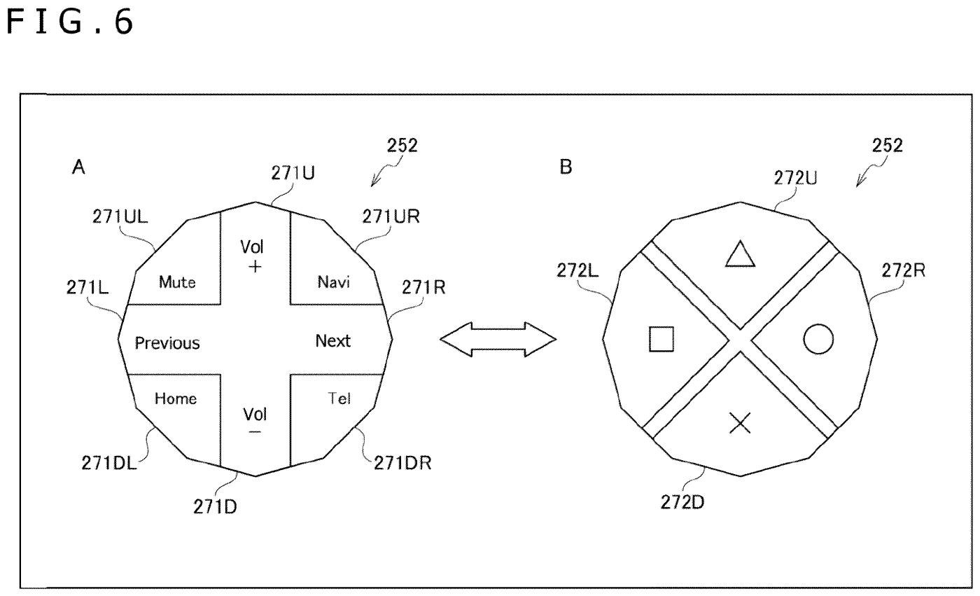

FIGS. 5 and 6 illustrate specific examples of the configuration of the steering switch 252.

A and B of FIG. 5 illustrate an example in which a plurality of operation regions of the steering switch 252 is formed by physical switches. Specifically, this steering switch 252 includes sub-switches 261U to 261R, which are formed by physical switches. The sub-switch 261U is disposed in an upper portion of the steering switch 252. The sub-switch 261D is disposed in a lower portion of the steering switch 252. The sub-switch 261L is disposed in a left portion of the steering switch 252. The sub-switch 261R is disposed in a right portion of the steering switch 252.

Hereinafter, the sub-switches 261U to 261R will be referred to simply as sub-switches 261 unless they need to be distinguished from one another.

A display device is provided on a surface of each sub-switch 261. The display device is formed by, for example, an organic EL display.

Each sub-switch 261 allows a function that is to be operated thereby to be set individually, and allows the function that is to be operated thereby to be changed. In addition, each sub-switch 261 allows information (hereinafter referred to as function information) regarding the function that is to be operated thereby to be displayed individually thereon, and allows the contents of the display to be changed.

Note, however, that the arrangement of the sub-switches 261 is fixed because each sub-switch 261 is formed by a physical switch.

For example, in the example of A of FIG. 5, functions related to an operation of content (e.g., a video, music, or the like) to be played inside the vehicle are assigned to the steering switch 252. Specifically, a function of increasing the volume of content is assigned to the sub-switch 261U. A function of decreasing the volume of content is assigned to the sub-switch 261D. A function of returning current playback to a previous piece is assigned to the sub-switch 261L. A function of advancing the current playback to a next piece is assigned to the sub-switch 261R.

For example, in the example of B of FIG. 5, functions related to an operation of a game are assigned to the steering switch 252. Specifically, a triangle (Δ) key is assigned to the sub-switch 261U. A cross (x) key is assigned to the sub-switch 261D. A square (□) key is assigned to the sub-switch 261L. A circle (◯) key is assigned to the sub-switch 261R.

A and B of FIG. 6 illustrate an example in which the steering switch 252 includes a touchscreen panel. Specifically, for example, the steering switch 252 includes a capacitance sensor. A display device is provided on a front side of the capacitance sensor. The display device is formed by, for example, an organic EL display. The steering switch 252 is capable of changing in the arrangement (e.g., positions, number, shapes, etc.) of sub-switches (i.e., operation regions) through a change in the contents of display of the display device.

Specifically, in the example of A of FIG. 6, the steering switch 252 is divided into sub-switches 271U to 271DR. The sub-switch 271U is provided in an upper portion of the steering switch 252. The sub-switch 271D is provided in a lower portion of the steering switch 252. The sub-switch 271L is provided in a left portion of the steering switch 252. The sub-switch 271R is provided in a right portion of the steering switch 252. The sub-switch 271UL is provided in an upper left portion of the steering switch 252. The sub-switch 271DL is provided in a lower left portion of the steering switch 252. The sub-switch 271UR is provided in an upper right portion of the steering switch 252. The sub-switch 271DR is provided in a lower right portion of the steering switch 252.

The function of increasing the volume of content is assigned to the sub-switch 271U. The function of decreasing the volume of content is assigned to the sub-switch 271D. The function of returning the current playback to a previous piece is assigned to the sub-switch 271L. The function of advancing the current playback to a next piece is assigned to the sub-switch 271R. A function of muting the volume of content is assigned to the sub-switch 271UL. A function of displaying a home screen of a browser on a display in front of a driver's seat is assigned to the sub-switch 271DL. A function of displaying a navigation screen on the display in front of the driver's seat is assigned to the sub-switch 271UR. A function of activating a telephone is assigned to the sub-switch 271DR.

In the example of B of FIG. 6, the steering switch 252 is divided into sub-switches 272U to 272R in a manner similar to that of A and B of FIG. 5. In addition, functions similar to those of the sub-switches 261U to 261R in B of FIG. 5 are assigned to the sub-switches 272U to 272R.

Note that the steering switch 252 may include both a physical switch and a touchscreen panel in combination, for example.

In addition, an example in which the steering switch 252 includes a touchscreen panel as illustrated in FIG. 6 will be described below.

### <Steering Switch Control Process>

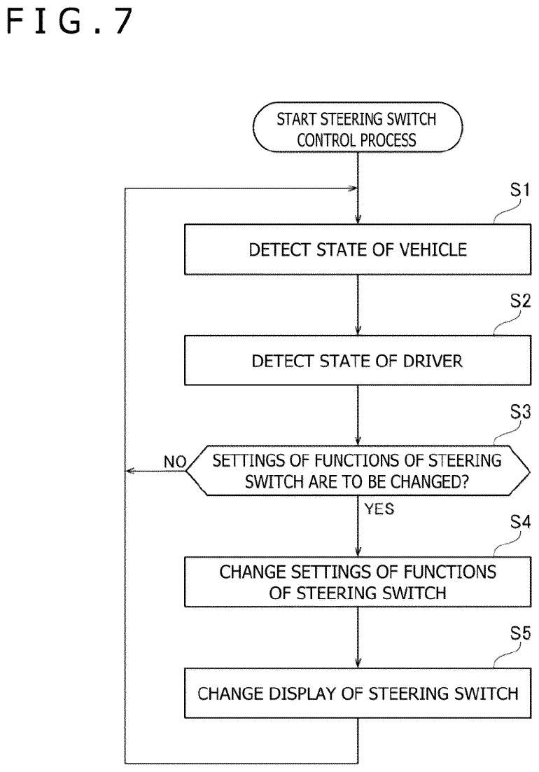

Next, a steering switch control process performed by the operation system 201 will be described below with reference to a flowchart of FIG. 7.

This process is, for example, started when power of the vehicle 1 has been turned on, and ends when the power of the vehicle 1 has been turned off.

At step S1, the vehicle state detection unit 213 detects the state of the vehicle 1 on the basis of data from the vehicle control ECU 21, sensor data from the vehicle sensor 27, control data from the vehicle control unit 32, and so on. For example, the vehicle state detection unit 213 detects whether the vehicle 1 is in a parked state, in a state of being during automated driving, or in a state of being during manual driving.

Here, the state of being during automated driving is, for example, a state in which an automated driving system is operating, and all dynamic driving tasks (DDTs) are performed by the vehicle 1 without a driving operation by the driver. Meanwhile, the state of being during manual driving is, for example, a state in which at least one of the DDTs is operated by the driver.

At step S2, the occupant state detection unit 214 detects the state of the driver on the basis of sensor data from the in-vehicle sensor 26, operation data from the operation unit 211, and so on. For example, the occupant state detection unit 214 detects whether the driver is in a state of enjoying content, in a state of playing a game, or in another state (hereinafter referred to as a normal state).

At step S3, the function setting unit 221 determines whether or not settings of the functions of the steering switch 252 are to be changed. For example, in the case where at least one of the state of the vehicle 1 and the state of the driver has been changed to satisfy conditions for changing the settings of the functions of the steering switch 252, the function setting unit 221 determines that the settings of the functions of the steering switch 252 are to be changed, and control proceeds to step S4.

At step S4, the function setting unit 221 changes the settings of the functions of the steering switch 252 on the basis of a setting condition based on at least one of the state of the vehicle 1 and the state of the driver.

At step S5, the display control unit 222 changes the display of the steering switch 252 according to the change in the settings of the functions of the steering switch 252.

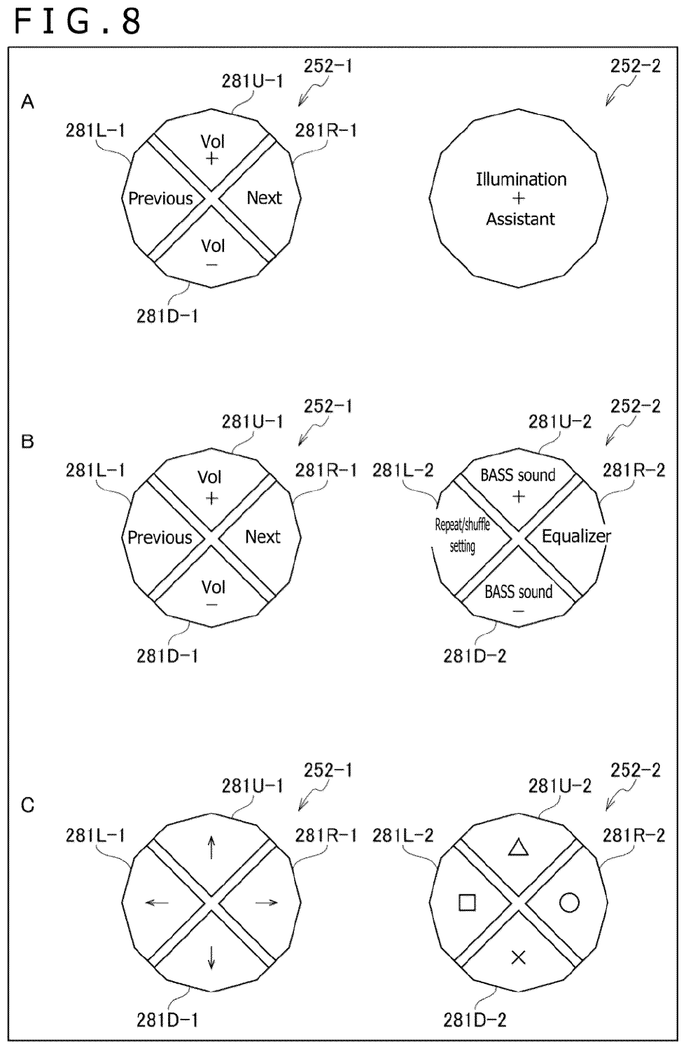

Here, example arrangements of the functions of each steering switch 252 will be described below with reference to FIGS. 8 to 10.

FIG. 8 illustrates example arrangements of functions of each steering switch 252 in the case where the vehicle 1 is in the parked state.

Portion A of FIG. 8 illustrates an example arrangement of the functions of each steering switch 252 in the case where the driver is in the normal state.

Specifically, the steering switch 252-1 is divided into sub-switches 281U-1 to 281R-1. The sub-switch 281U-1 is provided in an upper portion of the steering switch 252-1. The sub-switch 281D-1 is provided in a lower portion of the steering switch 252-1. The sub-switch 281L-1 is provided in a left portion of the steering switch 252-1. The sub-switch 281R-1 is provided in a right portion of the steering switch 252-1.

Functions related to the operation of content are assigned to the steering switch 252-1. Specifically, the function of increasing the volume of content is assigned to the sub-switch 281U-1. The function of decreasing the volume of content is assigned to the sub-switch 281D-1. The function of returning the current playback to a previous piece is assigned to the sub-switch 281L-1. The function of advancing the current playback to a next piece is assigned to the sub-switch 281R-1.

Hereinafter, the sub-switches 281U-1 to 281R-1 will be referred to simply as sub-switches 281-1 unless they need to be distinguished from one another.

On each of the sub-switches 281-1, function information regarding the function assigned thereto is displayed. The function information includes, for example, at least one of the name or abbreviation of the function, a description of the function, an image (e.g., an icon, a symbol, or the like) representing the function, and an operating method of the function.

Note that a character string displayed on each of the sub-switches 281-1 in portion A of FIG. 8 indicates the function of the sub-switch 281-1, and may not necessarily correspond with the function information that is actually displayed thereon. Similarly, a character string displayed on each of sub-switches in other examples that follow indicates the function of the sub-switch, and may not necessarily correspond with the function information that is actually displayed thereon.

The steering switch 252-2 is not divided into sub-switches.

An illumination function and an assistant function are assigned to the steering switch 252-2. For example, the brightness of lighting inside the vehicle and the irradiation position thereof can be set by continually pressing and operating the steering switch 252-2. The assistant function is carried out when the steering switch 252-2 is touched, for example.

The assistant function is, for example, a function that carries out various types of support for the driver through speech recognition. In addition, the assistant function, for example, provides a mode change function. The mode change function is, for example, a function that makes switching between a content enjoyment mode and a game mode, turns off an automated driving mode, and so on. For example, when the content enjoyment mode is set, functions related to the operation of content are preferentially assigned to the steering switch 252. For example, when the game mode is set, functions related to the operation of a game are preferentially assigned to the steering switch 252.

B of FIG. 8 illustrates example arrangements of the functions of the steering switches 252 in the case where the driver is enjoying content. In this case, the steering switches 252 are optimized for content playback.

Functions similar to those of the steering switch 252-1 in portion A of FIG. 8 are assigned to the steering switch 252-1.

The steering switch 252-2 is divided into sub-switches 281U-2 to 281R-2. The sub-switch 281U-2 is provided in an upper portion of the steering switch 252-2. The sub-switch 281D-2 is provided in a lower portion of the steering switch 252-2. The sub-switch 281L-2 is provided in a left portion of the steering switch 252-2. The sub-switch 281R-2 is provided in a right portion of the steering switch 252-2.

Functions related to the operation of content are assigned to the steering switch 252-2. Specifically, a function of increasing the volume of BASS sound of content is assigned to the sub-switch 281U-2. A function of decreasing the volume of BASS sound of content is assigned to the sub-switch 281D-2. A function of setting repeat/shuffle playback for pieces is assigned to the sub-switch 281L-2. A function of adjusting settings of an equalizer that changes frequency characteristics of audio of content is assigned to the sub-switch 281R-2.

C of FIG. 8 illustrates example arrangements of the functions of the steering switches 252 in the case where the driver is playing a game. In this case, the steering switches 252 serve as a game controller.

The steering switch 252-1 is divided into the sub-switches 281U-1 to 281R-1 as in A of FIG. 8.

Functions related to the operation of a game are assigned to the steering switch 252-1. Specifically, an Up key is assigned to the sub-switch 281U-1. A Down key is assigned to the sub-switch 281D-1. A Left key is assigned to the sub-switch 281L-1. A Right key is assigned to the sub-switch 281R-1.

The steering switch 252-2 is divided into the sub-switches 281U-2 to 281R-2 as in B of FIG. 8.

Functions related to the operation of a game are assigned to the steering switch 252-2. Specifically, a triangle (Δ) key is assigned to the sub-switch 281U-2, and a cross (x) key is assigned to the sub-switch 281D-2. A square (□) key is assigned to the sub-switch 281L-2. A circle ◯) key is assigned to the sub-switch 281R-2.

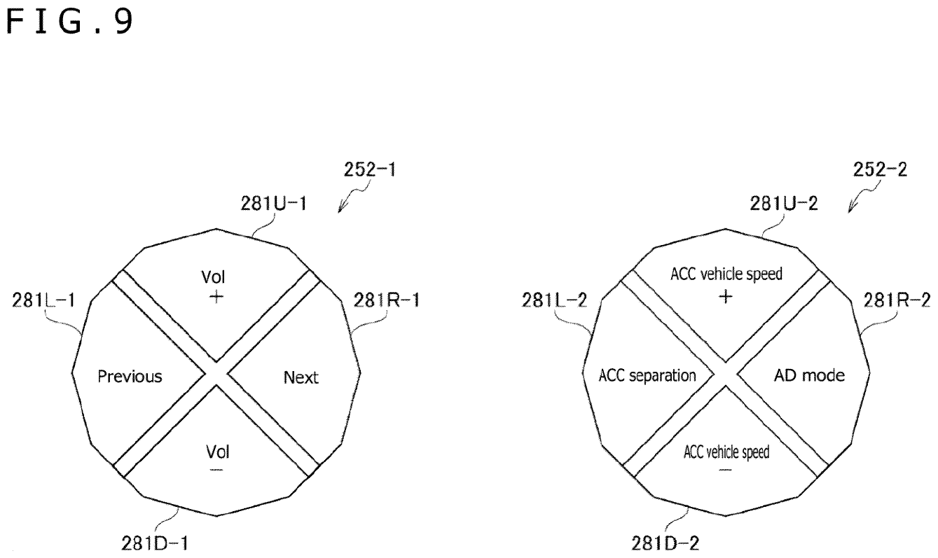

FIG. 9 illustrates example arrangements of the functions of the steering switches 252 in the case where the vehicle 1 is in the state of being during manual driving. In the case where the vehicle 1 is in the state of being during manual driving, the same functions are assigned to the steering switches 252 regardless of the state of the driver. That is, functions suitable for the manual driving are assigned to the steering switches 252.

Specifically, functions similar to those in A of FIG. 8 are assigned to the steering switch 252-1.

The steering switch 252-2 is divided into the sub-switches 281U-2 to 281R-2 as in B of FIG. 8.

Functions related to driving assistance are assigned to the steering switch 252-2. Specifically, a function of increasing the maximum speed of the vehicle 1 in the ACC (i.e., a vehicle-to-vehicle distance controller) is assigned to the sub-switch 281U-2. A function of decreasing the maximum speed of the vehicle 1 in the ACC is assigned to the sub-switch 281D-2. A function of setting a vehicle-to-vehicle distance in the ACC is assigned to the sub-switch 281L-2. A function of turning on the AD (automated driving) mode is assigned to the sub-switch 281R-2.

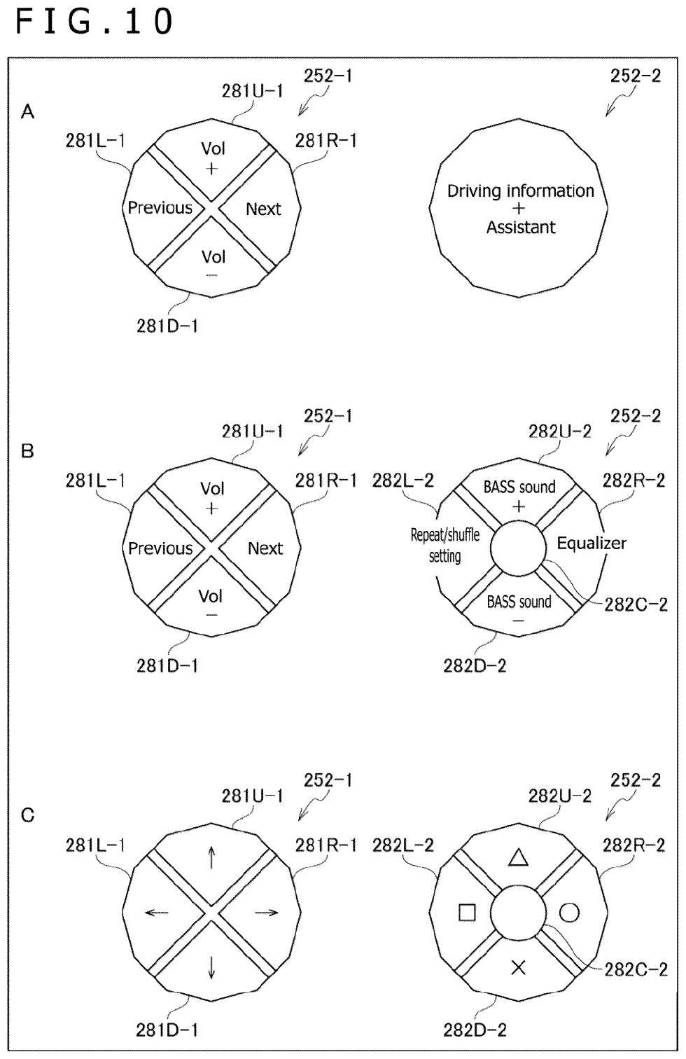

FIG. 10 illustrates example arrangements of the functions of each steering switch 252 in the case where the vehicle 1 is in the state of being during automated driving.

A of FIG. 10 illustrates an example arrangement of functions of each steering switch 252 in the case where the driver is in the normal state.

Functions similar to those in A of FIG. 8 are assigned to the steering switch 252-1.

The steering switch 252-2 is not divided into sub-switches.

A driving information display function and an assistant function are assigned to the steering switch 252-2. For example, when the steering switch 252-2 is continually pressed and operated, various types of information concerning driving of the vehicle 1 are displayed on the display in front of the driver's seat. For example, when the steering switch 252-2 is touched, the assistant function is carried out.

B of FIG. 10 illustrates an example arrangement of the functions of each steering switch 252 in the case where the driver is enjoying content. In this case, the steering switches 252 are optimized for content playback.

Functions similar to those in A of FIG. 8 are assigned to the steering switch 252-1.

The steering switch 252-2 is divided into sub-switches 282U-2 to 282C-2. The sub-switch 282U-2 is provided in an upper portion of the steering switch 252-2. The sub-switch 282D-2 is provided in a lower portion of the steering switch 252-2. The sub-switch 282L-2 is provided in a left portion of the steering switch 252-2. The sub-switch 282R-2 is provided in a right portion of the steering switch 252-2. The sub-switch 282C-2 is provided in a center of the steering switch 252-2.

Functions related to the operation of content are assigned to the steering switch 252-2. Specifically, functions similar to those of the sub-switch 281U-2, the sub-switch 281D-2, the sub-switch 281L-2, and the sub-switch 281R-2 in B of FIG. 8 are assigned to the sub-switch 282U-2, the sub-switch 282D-2, the sub-switch 282L-2, and the sub-switch 282R-2, respectively. An assistant function is assigned to the sub-switch 282C-2. For example, when the sub-switch 282C-2 is pressed and held down, the assistant function is carried out.

C of FIG. 10 illustrates an example arrangement of the functions of each steering switch 252 in the case where the driver is playing a game. In this case, the steering switches 252 serve as a game controller.

Functions similar to those in C of FIG. 8 are assigned to the steering switch 252-1.

The steering switch 252-2 is divided into the sub-switches 282U-2 to 282C-2 as in B of FIG. 10.

Functions related to the operation of a game are assigned to the steering switch 252-2. Specifically, functions similar to those of the sub-switch 281U-2, the sub-switch 281D-2, the sub-switch 281L-2, and the sub-switch 281R-2 in C of FIG. 8 are assigned to the sub-switch 282U-2, the sub-switch 282D-2, the sub-switch 282L-2, and the sub-switch 282R-2, respectively. An assistant function is assigned to the sub-switch 282C-2. For example, when the sub-switch 282C-2 is pressed and held down, the assistant function is carried out.

Referring back to FIG. 7, after the process of step S5, control returns to step S1, and the processes from step S1 onward are performed.

Meanwhile, in the case where it is determined at step S3 that the settings of the functions of the steering switch 252 are not to be changed, control returns to step S1, and the processes from step S1 onward are performed.

As described above, the functions and display of the steering switches 252 are changed according to at least one of the state of the vehicle 1 and the state of the driver. This leads to improved operability of the vehicle 1.

For example, it is made possible for the driver to, while the vehicle 1 is traveling, operate a function that is used during travel without removing a hand from the steering wheel 251. It is also made possible for the driver to correctly recognize and operate the function of each of the sub-switches of the steering switch 252 since the function information regarding the function assigned to each sub-switch is displayed on the sub-switch.

Note that, for example, in some countries, laws, regulations, etc., may require that the positions of telltales and operation devices related to driving functions, such as braking and steering, be fixed at the time of receiving type approval certification. In this case, for example, the positions and display of sub-switches for performing operations related to driving functions are fixed, while the functions of the other sub-switches are made variable.

### 3. Example Modifications

Example modifications of the embodiment of the present technology described above will be described below.

### <Example Modifications Concerning How Functions of Steering Switch 252 are Set>

For example, a manner in which the steering switch 252 is divided into sub-switches, and a function to be assigned to each sub-switch, may be set on the basis of a user operation. For example, an occupant, such as the driver, may be allowed to, using the operation units 211, set the manner in which the steering switch 252 is divided into sub-switches, and the function to be assigned to each sub-switch, in each of setting conditions based on at least one of the state of the vehicle 1 and the state of the driver.

For example, the learning unit 212 may be configured to learn characteristics (e.g., preferences, habits, etc.) of the driver on the basis of at least one of a history of operations performed by the driver on the operation units 211 and a history of use of functions of the HMI 31 by the driver. In addition, the function setting unit 221 may be configured to, on the basis of the characteristics of the driver, set the manner in which the steering switch 252 is divided into sub-switches, and the function to be assigned to each sub-switch, in each of the setting conditions based on at least one of the state of the vehicle 1 and the state of the driver.

This leads to, for example, arrangement of functions that are used by the driver with a high frequency on the steering switch 252, resulting in improved operability for the driver.

### <Example Modifications Concerning Variable Operation Units>

For example, like the functions of the steering switches 252 described above, functions to be carried out by a switch disposed in a place other than the steering wheel 251 inside the vehicle 1 may be made variable.

For example, functions to be carried out by a switch to be operated by an occupant other than the driver inside the vehicle 1 may be made variable.

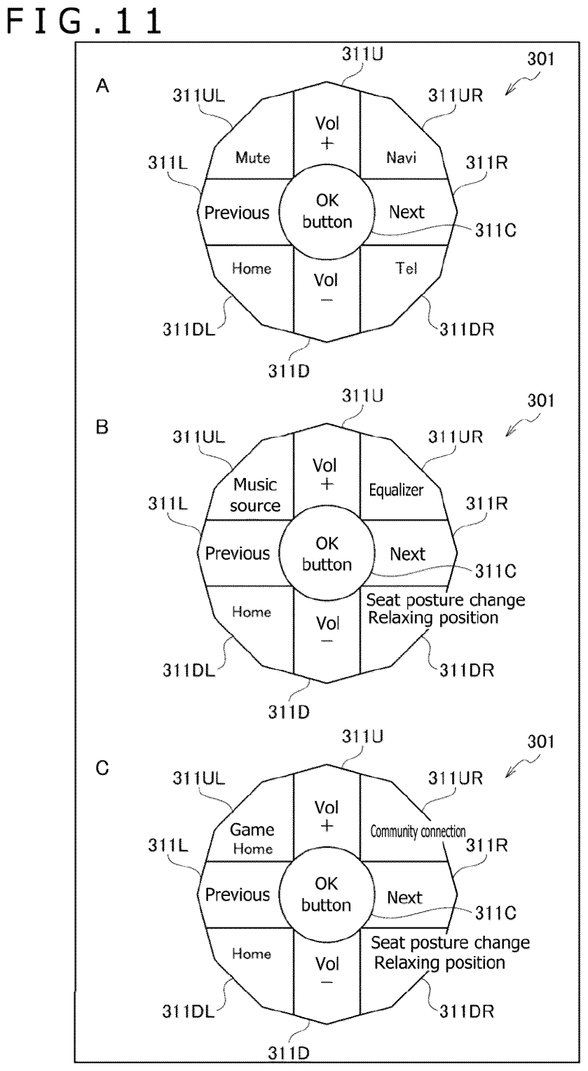

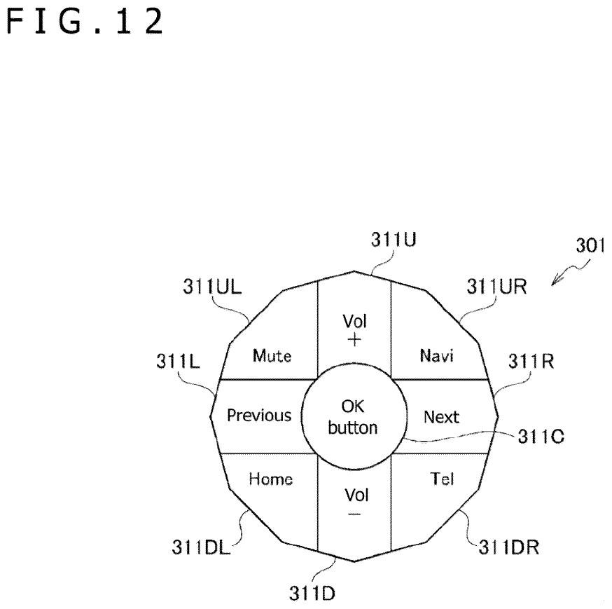

FIGS. 11 and 12 illustrate example arrangements of functions of a variable operation switch 301 to be operated by an occupant other than the driver.

FIG. 11 illustrates example arrangements of the functions of the variable operation switch 301 in the case where the vehicle 1 is in the parked state or in the state of being during automated driving.

A of FIG. 11 illustrates an example arrangement of the functions of the variable operation switch 301 in the case where the occupant is in the normal state.

The variable operation switch 301 is divided into sub-switches 311U to 311DR. The sub-switch 311U is provided in an upper portion of the variable operation switch 301. The sub-switch 311D is provided in a lower portion of the variable operation switch 301. The sub-switch 311L is provided in a left portion of the variable operation switch 301. The sub-switch 311R is provided in a right portion of the variable operation switch 301. The sub-switch 311UL is provided in an upper left portion of the variable operation switch 301. The sub-switch 311DL is provided in a lower left portion of the variable operation switch 301. The sub-switch 311UR is provided in an upper right portion of the variable operation switch 301. The sub-switch 311DR is provided in a lower right portion of the variable operation switch 301. The sub-switch 311C is provided in a center of the variable operation switch 301.

The function of increasing the volume of content is assigned to the sub-switch 311U. The function of decreasing the volume of content is assigned to the sub-switch 311D. The function of returning the current playback to a previous piece is assigned to the sub-switch 311L. The function of advancing the current playback to a next piece is assigned to the sub-switch 311R. The function of muting the volume of content is assigned to the sub-switch 311UL. A function of displaying a home screen of a browser on a display for the occupant is assigned to the sub-switch 311DL. A function of displaying a navigation screen on the display for the occupant is assigned to the sub-switch 311UR. The function of activating a telephone is assigned to the sub-switch 311DR. An OK button is assigned to the sub-switch 311C.

B of FIG. 11 illustrates an example arrangement of the functions of the variable operation switch 301 in the case where the occupant is enjoying content.

The variable operation switch 301 is divided into the sub-switches 311U to 311C as in A of FIG. 11.

Functions similar to those in A of FIG. 11 are assigned to the sub-switch 311U, the sub-switch 311D, the sub-switch 311L, the sub-switch 311R, the sub-switch 311DL, and the sub-switch 311C. A function of selecting a music source is assigned to the sub-switch 311UL. The function of adjusting the settings of an equalizer that changes frequency characteristics of audio of content is assigned to the sub-switch 311UR. A function of changing the posture of a seat into a relaxing position is assigned to the sub-switch 311DR.

C of FIG. 11 illustrates an example arrangement of the functions of the variable operation switch 301 in the case where the occupant is playing a game.

The variable operation switch 301 is divided into the sub-switches 311U to 311C as in A of FIG. 11.

Functions similar to those in A of FIG. 11 are assigned to the sub-switch 311U, the sub-switch 311D, the sub-switch 311L, the sub-switch 311R, the sub-switch 311DL, and the sub-switch 311C. A function of displaying a home screen of a game being played is assigned to the sub-switch 311UL. A function of connecting to a community of a game being played is assigned to the sub-switch 311UR. The function of changing the posture of a seat into a relaxing position is assigned to the sub-switch 311DR.

FIG. 12 illustrates an example arrangement of the functions of the variable operation switch 301 in the case where the vehicle 1 is in the state of being during manual driving.

The variable operation switch 301 is divided into the sub-switches 311U to 311C as in A of FIG. 11, and has assigned thereto functions similar to those in A of FIG. 11.

The above arrangements lead to improved operability of the variable operation switch 301 to be operated by an occupant other than the driver. Note that a function may be assigned to each sub-switch of the variable operation switch 301 on the basis of characteristics of the occupant, a user operation, or the like.

For example, the types and shapes of operation units to which the present technology is applicable are not limited to particular types or shapes as long as functions to be carried out thereby and the contents of display thereon are variable. For example, the present technology is applicable to buttons, levers, and so on for a vehicle.

For example, in the case where an information processing terminal, such as a smartphone, is used to operate the vehicle 1, a function of an operation region in an operation unit of the information processing terminal, and display on the operation region, may be changed as in the case described above. For example, the variable operation switch 301 of FIGS. 11 and 12 may be displayed on the information processing terminal on the basis of a setting condition based on at least one of the state of the vehicle 1 and the state of the occupant.

For example, the types of vehicles to which the present technology is applicable are not limited to particular types.

For example, the present technology is also applicable to operation units of movable bodies other than vehicles.

### 4. Others

### <Example Configuration of Computer>

The series of processes described above may also be implemented either in hardware or in software. In the case where the series of processes is implemented in software, a program that forms the software is installed onto a computer. Examples of such a computer include a computer having a dedicated hardware configuration, and a general-purpose personal computer or the like, for example, that, when various programs are installed thereon, becomes capable of performing various functions.

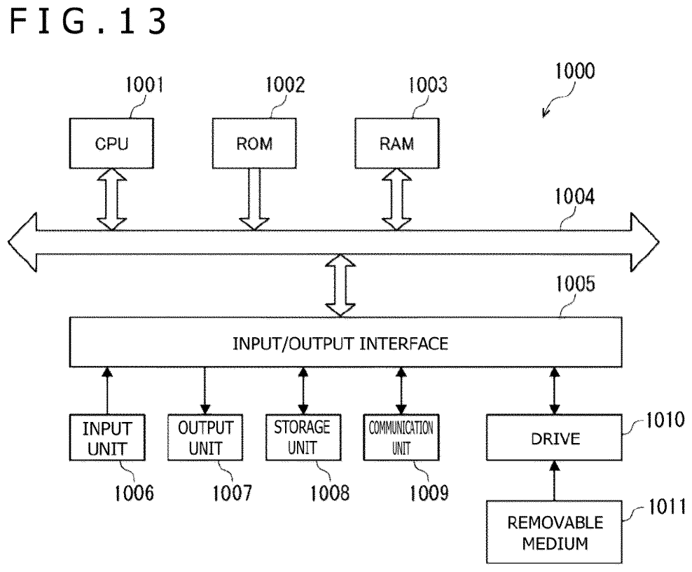

FIG. 13 is a block diagram illustrating an exemplary hardware configuration of a computer that performs the series of processes described above according to the program.

In a computer 1000, a CPU (Central Processing Unit) 1001, a ROM (Read Only Memory) 1002, and a RAM (Random Access Memory) 1003 are connected to one another via a bus 1004.

Further, an input/output interface 1005 is connected to the bus 1004. An input unit 1006, an output unit 1007, a storage unit 1008, a communication unit 1009, and a drive 1010 are connected to the input/output interface 1005.

The input unit 1006 is formed by an input switch, a button, a microphone, an imaging device, and/or the like. The output unit 1007 is formed by a display, a loudspeaker, and/or the like. The storage unit 1008 is formed by a hard disk, a nonvolatile memory, and/or the like. The communication unit 1009 is formed by a network interface and/or the like. The drive 1010 drives a removable medium 1011, such as a magnetic disk, an optical disk, a magneto-optical disk, or a semiconductor memory.

In the computer 1000 having the configuration described above, the CPU 1001 loads the program recorded on the storage unit 1008, for example, into the RAM 1003 via the input/output interface 1005 and the bus 1004, and executes the program to perform the series of processes described above.

The program to be executed by the computer 1000 (i.e., the CPU 1001) may be recorded on the removable medium 1011, which may be a packaged medium or the like, for example, and be thus provided. Alternatively, the program may be provided via a wired or wireless transmission medium, such as a local area network, the Internet, or digital satellite broadcasting.

In the computer 1000, the program may be installed into the storage unit 1008 via the input/output interface 1005 by mounting the removable medium 1011 on the drive 1010. Alternatively, the program may be received by the communication unit 1009 via the wired or wireless transmission medium and be installed into the storage unit 1008. Alternatively, the program may be installed into the ROM 1002 or the storage unit 1008 in advance.

Note that the program executed by the computer may be either a program that causes the processes to be performed chronologically in an order as described in the present specification, or a program that causes the processes to be performed in parallel or at times when they need be performed, such as when calls have been issued.

In addition, it is assumed in the present specification that the term “system” refers to a collection of multiple constituent elements (e.g., devices, modules (parts), etc.) regardless of whether all the constituent elements are contained in the same casing. Therefore, multiple devices that are housed in separate casings and are connected via a network, and a single device having multiple modules housed in a single casing, can both be referred to as systems.

Further, embodiments of the present technology are not limited to the embodiments described above, and it should be understood that various modifications can be made without departing from the scope of the gist of the present technology.

For example, the present technology may be implemented by cloud computing, in which a single function is realized by a plurality of devices cooperating and sharing processes via a network.

In addition, each of the steps described above with reference to the flowchart may be performed by a single device, or may alternatively be performed by a plurality of cooperating devices.

Further, in the case where one step includes a plurality of processes, the plurality of processes included in the one step may be performed by a single device, or may alternatively be performed by a plurality of cooperating devices.

### <Example Combinations of Configurations>

The present technology can have the following configurations as well.

(1)

An information processing apparatus including:
a function setting unit that sets a function to be carried out by an operation unit, on the basis of a setting condition based on at least one of a state of a vehicle and a state of an occupant of the vehicle; and a display control unit that controls display, on the operation unit, of function information regarding the function set for the operation unit.
   (2)

The information processing apparatus according to (1)
the function setting unit sets each of functions to be carried out by a plurality of operation regions of the operation unit on the basis of the setting condition, and
the display control unit controls display of the function information on each of the operation regions.
   (3)

The information processing apparatus according to (2) above, in which
the operation unit is variable in arrangement of the operation regions,
the function setting unit divides the operation unit into the plurality of operation regions, and sets the function to be carried out by each of the operation regions, on the basis of the setting condition, and
the display control unit controls display of each of the operation regions, and display of the function information on each of the operation regions.
   (4)

The information processing apparatus according to (3) above, in which
the operation unit includes a touchscreen panel.
   (5)

The information processing apparatus according to any one of (1) to (4) above, in which
the state of the occupant includes any one of a state of enjoying content, a state of playing a game, and another state.
   (6)

The information processing apparatus according to (5) above, in which
the function includes a function related to an operation of content, a function related to an operation of a game, and a function related to driving of the vehicle.
   (7)

The information processing apparatus according to any one of (1) to (6) above, in which
the state of the vehicle includes any one of a state of being during manual driving, a state of being during automated driving, and a parked state.
   (8)

The information processing apparatus according to any one of (1) to (7) above, in which
the function information includes at least one of a name or abbreviation of the function, a description of the function, an image representing the function, and an operating method of the function.
   (9)

The information processing apparatus according to any one of (1) to (8) above, in which
the operation unit is operated by a driver.
   (10)

The information processing apparatus according to (9) above, in which
the operation unit is disposed on a steering wheel of the vehicle.
   (11)

The information processing apparatus according to any one of (1) to (10) above, in which
the operation unit is disposed on an information processing terminal that is used to operate the vehicle.
   (12)

The information processing apparatus according to any one of (1) to (11) above, further including:
a learning unit that learns characteristics of the occupant on the basis of at least one of an operation history of the occupant and a history of use of the function by the occupant, in which
the function setting unit sets the function to be carried out by the operation unit, on the basis of the setting condition and the characteristics of the occupant.
   (13)

The information processing apparatus according to any one of (1) to (12) above, in which
the function setting unit sets the function to be carried out by the operation unit in each of the setting conditions, on the basis of a user operation.
   (14)

The information processing apparatus according to any one of (1) to (13) above, further including:
the operation unit.
   (15)

An information processing method including:
setting a function to be carried out by an operation unit, on the basis of a setting condition based on at least one of a state of a vehicle and a state of an occupant of the vehicle; and
controlling display, on the operation unit, of function information regarding the function set for the operation unit.
   (16)

A program for causing a computer to perform the processes of:
setting a function to be carried out by an operation unit, on the basis of a setting condition based on at least one of a state of a vehicle and a state of an occupant of the vehicle; and
controlling display, on the operation unit, of function information regarding the function set for the operation unit.

It is to be understood that advantageous effects mentioned in the present specification are merely illustrative and not restrictive, and that there may be

### REFERENCE SIGNS LIST

1: Vehicle
11: Vehicle control system
201: Operation system
211: Operation unit
212: Learning unit
213: Vehicle state detection unit
214: Occupant state detection unit
215: Variable operation unit control unit
221: Function setting unit
222: Display control unit
251: Steering wheel
252-1, 252-2: Steering switch
261U to 261R, 271U to 271R, 281U-1 to 282C-2: Sub-switch
301: Variable operation switch
311U to 311C: Sub-switch

1. An information processing apparatus comprising:
a function setting unit that sets a function to be carried out by an operation unit, on a basis of a setting condition based on at least one of a state of a vehicle and a state of an occupant of the vehicle; and
a display control unit that controls display, on the operation unit, of function information regarding the function set for the operation unit.

2. The information processing apparatus according to claim 1, wherein
the function setting unit sets each of functions to be carried out by a plurality of operation regions of the operation unit on the basis of the setting condition, and
the display control unit controls display of the function information on each of the operation regions.

3. The information processing apparatus according to claim 2, wherein
the operation unit is variable in arrangement of the operation regions,
the function setting unit divides the operation unit into the plurality of operation regions, and sets the function to be carried out by each of the operation regions, on the basis of the setting condition, and
the display control unit controls display of each of the operation regions, and display of the function information on each of the operation regions.

4. The information processing apparatus according to claim 3, wherein
the operation unit includes a touchscreen panel.

5. The information processing apparatus according to claim 1, wherein
the state of the occupant includes any one of a state of enjoying content, a state of playing a game, and another state.

6. The information processing apparatus according to claim 5, wherein
the function includes a function related to an operation of content, a function related to an operation of a game, and a function related to driving of the vehicle.

7. The information processing apparatus according to claim 1, wherein
the state of the vehicle includes any one of a state of being during manual driving, a state of being during automated driving, and a parked state.

8. The information processing apparatus according to claim 1, wherein
the function information includes at least one of a name or abbreviation of the function, a description of the function, an image representing the function, and an operating method of the function.

9. The information processing apparatus according to claim 1, wherein
the operation unit is operated by a driver.

10. The information processing apparatus according to claim 9, wherein
the operation unit is disposed on a steering wheel of the vehicle.

11. The information processing apparatus according to claim 1, wherein
the operation unit is disposed on an information processing terminal that is used to operate the vehicle.

12. The information processing apparatus according to claim 1, further comprising:
a learning unit that learns characteristics of the occupant on a basis of at least one of an operation history of the occupant and a history of use of the function by the occupant, wherein
the function setting unit sets the function to be carried out by the operation unit, on a basis of the setting condition and the characteristics of the occupant.

13. The information processing apparatus according to claim 1, wherein
the function setting unit sets the function to be carried out by the operation unit in each of the setting conditions, on a basis of a user operation.

14. The information processing apparatus according to claim 1, further comprising:
the operation unit.

15. An information processing method comprising:
setting a function to be carried out by an operation unit, on a basis of a setting condition based on at least one of a state of a vehicle and a state of an occupant of the vehicle; and
controlling display, on the operation unit, of function information regarding the function set for the operation unit.

16. A program for causing a computer to perform the processes of:
setting a function to be carried out by an operation unit, on a basis of a setting condition based on at least one of a state of a vehicle and a state of an occupant of the vehicle; and
controlling display, on the operation unit, of function information regarding the function set for the operation unit.
